(19) United States
(12) Patent Application Publication
(10) Pub. No.: US 2016/0076713 A1
(43) Pub. Date: Mar. 17, 2016

(54) ILLUMINATION DEVICE

(71) Applicant: PANASONIC INTELLECTUAL PROPERTY MANAGEMENT CO., LTD., Osaka (JP)

(72) Inventor: Ayako TSUKITANI, Osaka (JP)

(73) Assignee: PANASONIC INTELLECTUAL PROPERTY MANAGEMENT CO., LTD., Osaka (JP)

(21) Appl. No.: 14/847,185

(22) Filed: Sep. 8, 2015

(30) Foreign Application Priority Data
Sep. 11, 2014 (JP) 2014-185638

(51) Int. Cl. F21K 99/00; F21V 9/16

(52) U.S. Cl. CPC F21K 9/56; F21V 9/16; F21Y 2101/02

(57) ABSTRACT

An illumination device includes a solid light-emitting element and a wavelength converting unit configured to convert a wavelength of light emitted from the solid light-emitting element. The wavelength converting unit includes a first member spaced apart from the solid light-emitting element and installed so as to surround the solid light-emitting element, and a second member installed so as to cut off a part of a light path extending from the solid light-emitting element to the first member. The first member is provided with a first wavelength converting material unevenly coated on an inner surface thereof and is configured such that the relative position of the first member with respect to the second member is changeable, and the second member is provided with a second wavelength converting material coated on a surface thereof facing the solid light-emitting element.

### CROSS-REFERENCE TO RELATED APPLICATIONS

This application claims priority to Japanese Patent Application No. 2014-185638 filed on Sep. 11, 2014, the entire contents of which are incorporated herein by reference.

### TECHNICAL FIELD

The disclosure relates to an illumination device which uses an LED as a light source.

### BACKGROUND ART

LEDs are capable of providing high-brightness light emission with low electric power and have long lifespan. Thus, the LEDs draw attention as a light source alternative to an incandescent lamp and a fluorescent lamp. As one example of an illumination device which uses the LEDs as the light source, there is known an illumination device which includes a red LED for emitting red light, a green LED for emitting green light, a blue LED for emitting blue light and a white LED for emitting white light (see, e.g., Japanese Unexamined Patent Application Publication No. 2011-204659). This illumination device irradiates light of different colors by independently controlling the luminance of the respective LEDs.

However, in the aforementioned illumination device, the luminance of the respective LEDs needs to be independently controlled in order to change the colors of the irradiated light. Thus, the structure of the illumination device becomes complex.

### SUMMARY OF THE INVENTION

In view of the above, the disclosure provides an illumination device which uses a solid light-emitting element such as an LED or the like as a light source and which can change the color of irradiated light with a simple structure.

In accordance with an embodiment of the disclosure, there is provided an illumination device including: a solid light-emitting element; and a wavelength converting unit configured to convert a wavelength of light emitted from the solid light-emitting element. The wavelength converting unit includes a first member spaced apart from the solid light-emitting element and installed so as to surround the solid light-emitting element, and a second member installed so as to cut off a part of a light path extending from the solid light-emitting element to the first member. Further, the first member is provided with a first wavelength converting material unevenly coated on an inner surface thereof and is configured such that the relative position of the first member with respect to the second member is changeable, and the second member is provided with a second wavelength converting material coated on a surface thereof facing the solid light-emitting element.

With such configuration, when the relative position of the first member with respect to the second member is changed, the amount of light wavelength-converted by the first wavelength converting material is changed. It is therefore possible to change the color of irradiated light with a simple structure.

### BRIEF DESCRIPTION OF THE DRAWINGS

The figures depict one or more implementations in accordance with the present teaching, by way of example only, not by way of limitations. In the figures, like reference numerals refer to the same or similar elements.

FIG. 1 is an exploded perspective view of an illumination device according to a first embodiment.

FIGS. 2A and 2B are plan views showing the arrangement of a first member and a second member in the illumination device of the first embodiment.

FIGS. 3A and 3B are plan views showing the arrangement of a first member and a second member in an illumination device according to a modification of the first embodiment.

FIG. 4 is an exploded perspective view of an illumination device according to a second embodiment.

FIGS. 5A and 5B are plan views showing the arrangement of a first member and a second member in the illumination device of the second embodiment.

### DETAILED DESCRIPTION

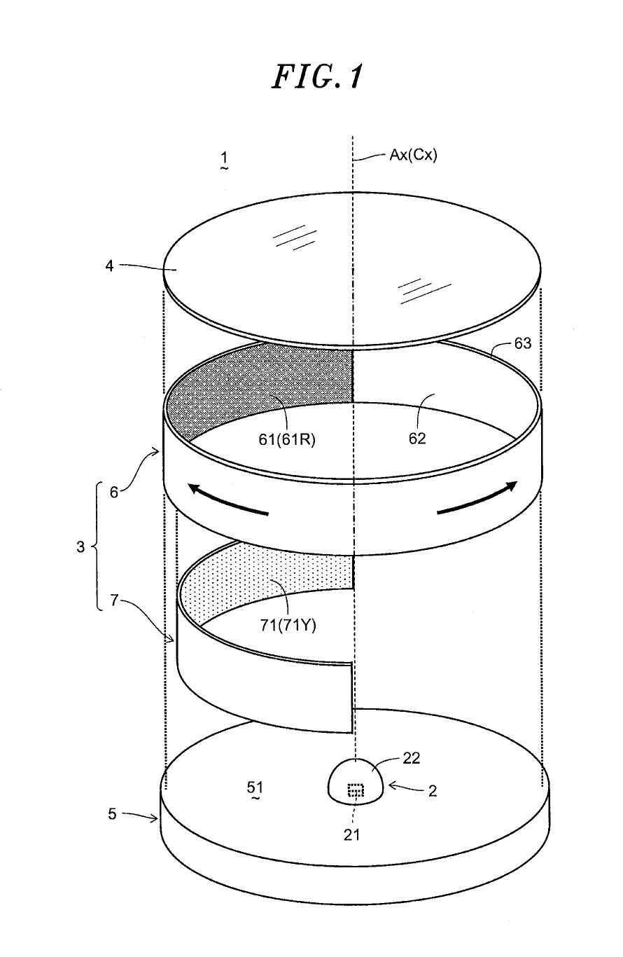

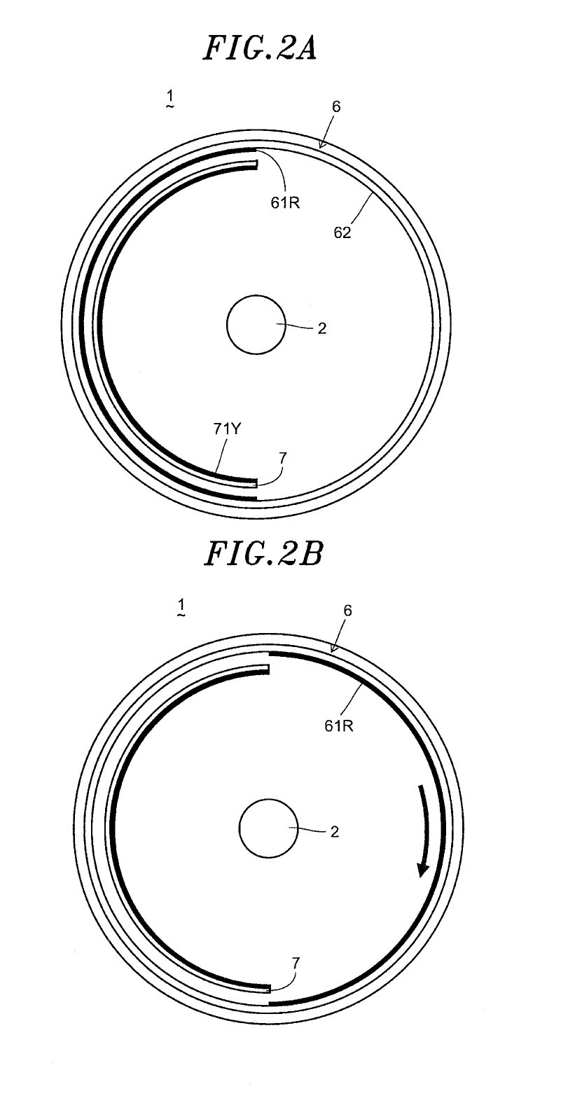

An illumination device according to a first embodiment of the disclosure will be described with reference to FIGS. 1 to 2B. As shown in FIG. 1, the illumination device 1 includes a solid light-emitting element such as LED 2, a wavelength converting unit 3 for converting the wavelength of light emitted from the LED 2, and a diffusing unit 4 for diffusing and projecting the light emitted from the LED 2 and the light whose wavelength is converted by the wavelength converting unit 3 to the outside.

The LED 2 is mounted on one surface (a mounting surface) of a disc-shaped support body 5. The support body accommodates therein a circuit unit (not shown) for controlling light emission of the LED 2. The circuit unit controls the power feeding from a commercial power source to the LED 2.

The LED 2 includes an LED chip 21 for emitting blue light and a lens 22 installed so as to cover the LED chip 21 and configured to control distribution of the blue light emitted from the LED chip 21. The LED chip 21 is disposed at the center of the mounting surface 51 such that the optical axis Ax thereof is orthogonal to the mounting surface 51. The lens 22 is configured by a wide-angle lens which refracts the light emitted from the LED chip 21 in a direction having an angle of 70 degrees with respect to the optical axis Ax.

The wavelength converting unit 3 includes a first member 6 spaced apart from the LED 2 and installed so as to surround the LED 2, and a second member 7 installed so as to cut off a part of a light path from the LED 2 to the first member 6. The first member 6 is formed into a cylindrical shape. The second member 7 is formed into a shape of a semi-cylinder having a height substantially equal to the height of the first member 6 and a radius smaller than the radius of the first member 6. The first member 6 and the second member 7 are disposed such that the cylinder axis Cx thereof coincides with the optical axis Ax of the LED 2. The first member 6 is held on the mounting surface 51 so that it can rotate about the cylinder axis Cx. The second member 7 is fixed to the mounting surface 51 so that it cannot be rotated. Thus, when the first member 6 is rotated, it is possible to change the relative position of the first member 6 to the second member 7.

The first member 6 includes a first wavelength converting material 61 unevenly coated on the inner surface thereof. In the illustrated example, the first wavelength converting material 61 is coated on one half of the inner surface of the first member 6 and is composed of a red phosphor 61R which can be excited by the light emitted from the LED 2 to emit red light. The red phosphor 61R is composed of, e.g., a CASN-based red phosphor. The other half of the inner surface of the first member 6 is formed of a reflection surface 62 which is configured to have a high light reflectivity by the coating of a white paint or the vapor deposition of a light-reflecting material. The reflection surface 62 reflects light without changing the wavelength thereof.

The second member 7 includes a second wavelength converting material 71 coated on the surface (inner surface) thereof facing the LED 2. In the illustrated example, the second wavelength converting material 71 is coated on the entirety of the inner surface of the second member 7 and is composed of a yellow phosphor 71Y which can be excited by the light emitted from the LED 2 to emit yellow light. The yellow phosphor 71Y is composed of, e.g., a YAG-based yellow phosphor.

The diffusing unit 4 is formed into a disc shape and is fixedly secured to an end portion 63 of the first member opposite to that of the first member 6 held on the mounting surface 51 such that the diffusing unit 4 is orthogonal to the optical axis Ax. The diffusing unit 4 is made of, e.g., a milky white light-transmitting material. Furthermore, the diffusing unit 4 may be formed by attaching a diffusion sheet for diffusing light to the surface of a light-transmitting plate or by subjecting the surface of a light-transmitting plate to frost processing. By installing the diffusing unit 4, the light directly emitted to the outside from the LED 2 can be mixed with the light emitted from the LED 2 and wavelength-converted by the red phosphor 61R or the yellow phosphor 71Y. This makes it possible to reduce color unevenness of the irradiated light.

A method of using the illumination device 1 configured as above will be described with reference to FIGS. 2A and 2B. In the example illustrated in FIGS. 2A and 2B, the diffusing unit 4 is not shown. As shown in FIG. 2A, when the red phosphor 61R of the first member 6 is hidden by the second member 7 when seen from the LED 2, a part of the blue light emitted from the LED 2 reaches the second member 7 where the blue light is wavelength-converted to yellow light by the yellow phosphor 71Y. The yellow light is mixed with the blue light, which is emitted from the LED 2 and reflected by the reflection surface 62 of the first member 6, or with the blue light, which is emitted from the LED 2 and directly incident on the diffusing unit 4, to provide white light. The white light is diffused in different directions in the diffusing unit 4 and is irradiated to the outside.

As shown in FIG. 2B, when the first member 6 is rotated 180 degrees from the state shown in FIG. 2A, the red phosphor 61R hidden by the second member 7 when seen from the LED 2 is now exposed. Thus, a part of the blue light emitted from the LED 2 is wavelength-converted into red light by the red phosphor 61R. The red light is mixed with the white light obtained by mixing the blue light emitted from the LED 2 and the yellow light wavelength-converted by the second member 7, thereby giving rise to warm white light which has a low color temperature. At this time, the color temperature of the white light is decided by the rotation amount of the first member 6. By rotating the first member 6, it is possible to continuously and smoothly change the color temperature of the irradiated light.

As described above, according to the illumination device 1, the degree of exposure of the red phosphor 61R (or the first wavelength converting material 61) when seen from the LED 2 can be changed by rotating the first member 6 and changing the relative position of the first member 6 to the second member 7. Thus, the amount of the light emitted from the LED 2 and wavelength-converted by the red phosphor 61R is changed. This makes it possible to change the color of the irradiated light with a simple structure. The change in the color of the irradiated light can be achieved without performing electric control such as diming/color mixing control or the like with respect to the LED 2.

Further, in the state shown in FIG. 2B, the phosphors (the red phosphor 61R and the yellow phosphor 71Y) are disposed over 360 degrees around the LED 2. It is therefore possible to highly wavelength-convert the light emitted from the LED 2, thereby greatly changing the color of the irradiated light. Furthermore, since the LED 2 is configured to emit blue light having a short wavelength and high energy, it is possible to efficiently excite different kinds of phosphors, thereby expanding the color change variations of the irradiated light, as compared with a case where the LED 2 is configured to emit white light.

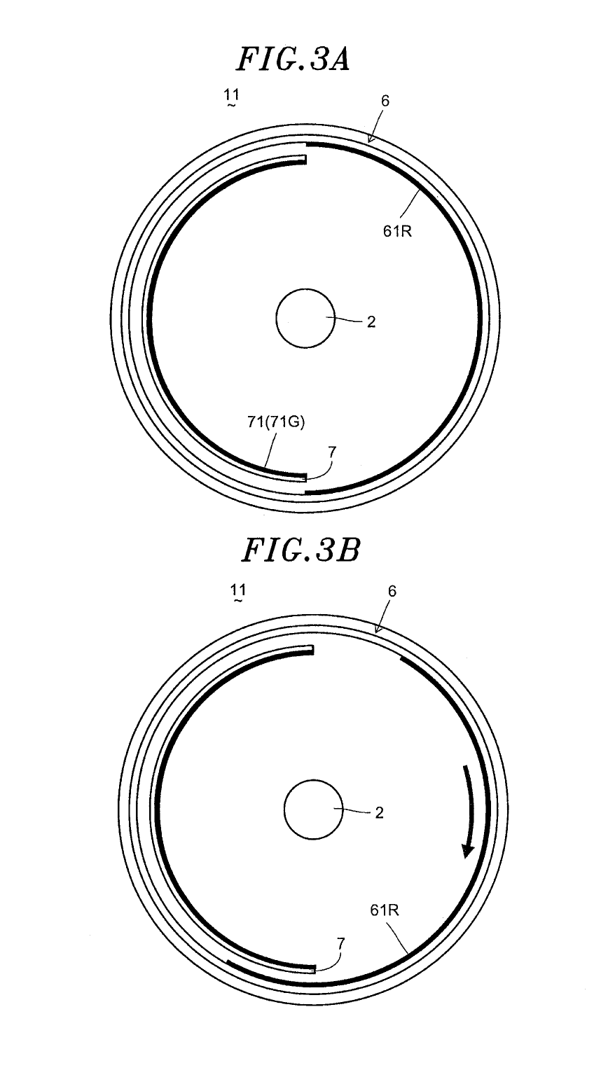

Next, an illumination device 11 according to a modification of the first embodiment will be described with reference to FIGS. 3A and 3B. The illumination device 11 is configured based on the aforementioned illumination device 1 except that the second wavelength converting material 71 is configured by a green phosphor 71G which is excited by blue light to emit green light. The green phosphor 71G is configured by, e.g., a BOSE-based green phosphor.

As shown in FIG. 3A, when the red phosphor 61R is not hidden by the second member 7 when seen from the LED 2, the light emitted from the illumination device 11 becomes white light which is a mixture of the blue light emitted from the LED 2, the red light wavelength-converted by the red phosphor 61R and the green light wavelength-converted by the green phosphor 71G. This white light has an average color rendering index Ra higher than that of the white light irradiated from the illumination device 1 and can clearly illuminate an illumination target.

When the first member 6 is rotated as shown in FIG. 3B from the state shown in FIG. 3A, a part of the red phosphor 61R is hidden by the second member 7 when seen from the LED 2. As a result, the amount of the red color is reduced. It is therefore possible to shift the color temperature of the irradiated light toward the high temperature side. The phosphors which constitute the first wavelength converting material 61 and the second wavelength converting material 71 are not limited to the aforementioned ones but may be appropriately selected depending on the colors of the irradiated light to be obtained. In addition, the phosphors may be configured by the same kind of phosphor. For example, all the phosphors may be configured by yellow phosphors.

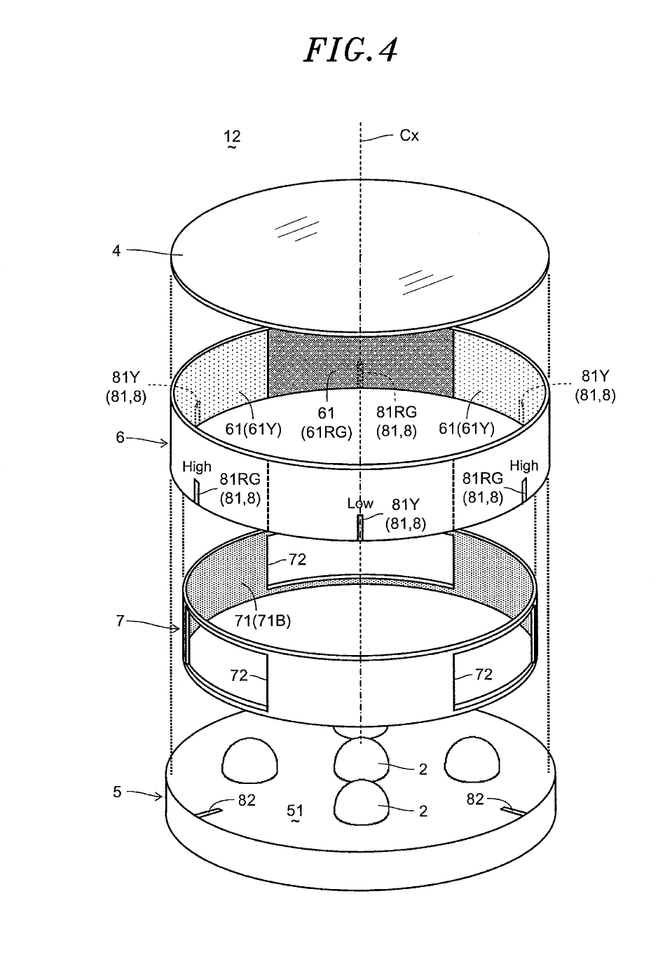

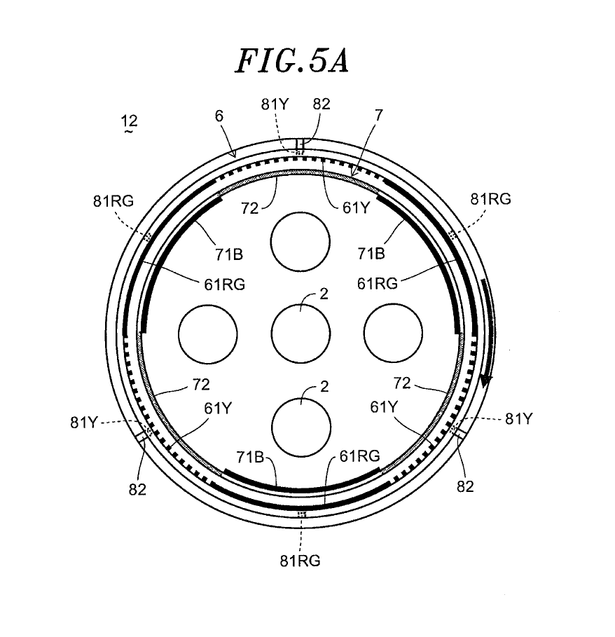

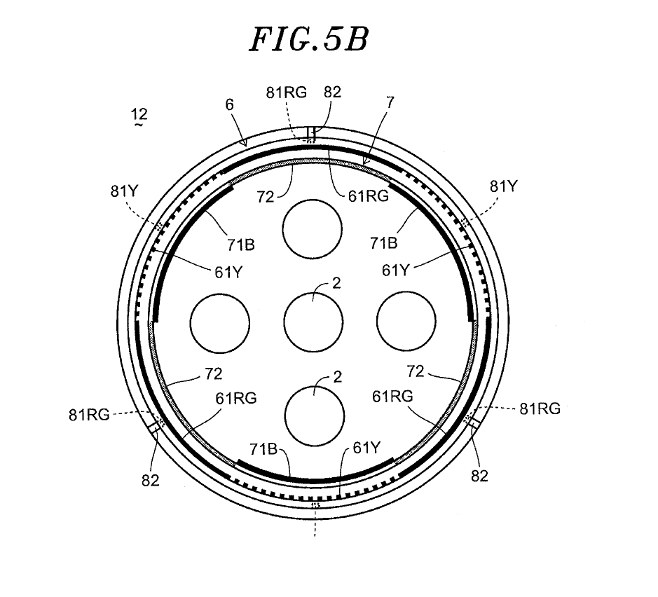

Next, an illumination device 12 according to a second embodiment will be described with reference to FIGS. 4 to 5B. As shown in FIG. 4, the illumination device 12 is configured based on the aforementioned illumination device 1 except that the shape of the second member 7 is changed and the LEDs 2 are configured to emit light ranging from near-ultraviolet light to violet light. In the illustrated example, a plurality of LEDs 2 is installed. A filter (not shown) which absorbs near-ultraviolet light is attached to the surface of the diffusing unit 4 such that the near-ultraviolet light is not projected to the outside from the illumination device 12.

The second member 7 of the illumination device 12 is formed into a cylindrical shape and includes, as the second wavelength converting material 71, a blue phosphor 71B which is excited by the light emitted from the LED 2 to emit blue light. The blue phosphor 71B is configured by, e.g., a Eu activated phosphate-based blue phosphor. Furthermore, the second member 7 includes openings 72 formed to penetrate through the side surface thereof. When seen from the cylinder axis Cx, the openings 72 are formed at a predetermined angular interval with one another along the circumferential direction of the second member 7. In the illustrated example, three openings 72 are formed at an interval of 120 degrees. While the openings 72 are formed into a rectangular shape in the illustrated example, the shape of the openings 72 is not limited to the rectangular shape but may be, e.g., a circular shape.

The first wavelength converting materials 61 include yellow phosphors 61Y and phosphors 61RG obtained by mixing a red phosphor and a green phosphor. Layers including the yellow phosphors 61Y and layers including the phosphors 61RG are alternately disposed along the circumferential direction of the first member 6 and are provided at an interval of 120 degrees in the illustrated example.

The illumination device 12 further includes indicators 8 which indicate the relative position of the first member 6 with respect to the second member 7 and a property of the irradiated light (i.e., a color rendering property of white light emitted from the illumination device) corresponding to the relative position. The indicators 8 includes first marks 81 formed on the outer surface of the first member 6 and second marks 82 formed in the peripheral edge portion of the mounting surface 51 of the support body 5. In the illustrated example, the first marks 81 are formed of cuts and are configured by marks 81Y respectively formed in the layers including the yellow phosphors 61Y and marks 81RG respectively formed in the layers including the phosphors 61RG. In view of the level of a color rendering property (see a description made below) of the irradiated light obtained by the phosphors 61RG and the level of a color rendering property of the irradiated light obtained by the yellow phosphors 61Y, the marks 81RG and 81Y are appended with characters reading “High” and “Low”. Similar to the first marks 81, the second marks 82 are formed of cuts and are provided in the positions corresponding to the openings 72 of the second member 7 fixed to the support body 5.

As shown in FIG. 5A, when the first member 6 is rotated such that the marks 81Y are aligned with the second marks 82, the yellow phosphors 61Y (indicated by broken lines) are exposed through the openings 72 (indicated by dots). Thus, a part of the light emitted from the LEDs 2 passing through the openings 72 is converted to yellow light by the yellow phosphors 61Y. Another part of the light emitted from the LEDs 2 is converted to blue light by the blue phosphors 71B of the second member 7. The yellow light and the blue light are mixed so that white light is irradiated to the outside.

As shown in FIG. 5B, when the first member 6 is rotated 60 degrees from the state shown in FIG. 5A such that the marks 81RG are aligned with the second marks 82, the phosphors 61RG are exposed through the openings 72. Thus, a part of the light emitted from the LEDs 2 passing through the openings 72 is converted to red light and green light by the phosphors 61RG. The red light and the green light are mixed with the blue light converted by the blue phosphors 71B of the second member 7, whereby white light is irradiated to the outside. This white light has an average color rendering index Ra higher than that of the white light obtained in the state shown in FIG. 5A.

As described above, in the illumination device 12, there are provided different kinds of first wavelength converting materials 61. The color of the irradiated light can be changed by changing the relative positions of the openings 72 with respect to the first wavelength converting materials 61. By providing the indicators 8, it becomes easy to know how to obtain the irradiated light having a desired color by rotating the first member 6 with respect to the second member 7. This makes it possible to improve the operability.

The illumination device according to the disclosure is not limited to the aforementioned embodiments and the modifications thereof but may be differently modified. As an example, the first wavelength converting material and the second wavelength converting material may not be configured by the phosphors but may be configured by, e.g., wavelength filters which absorb light of specified wavelength ranges. Furthermore, the external shape of the illumination device is not limited to the circular columnar shape mentioned above but may be, e.g., a prismatic shape. Moreover, the solid light-emitting element is not limited to the LED but may be configured by, e.g., an organic EL element. In addition, the illumination device of the disclosure is not necessarily provided with the diffusing unit but may be configured so as not to include the diffusing unit.

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present teachings.

What is claimed is:

1. An illumination device, comprising:
a solid light-emitting element; and
a wavelength converting unit configured to convert a wavelength of light emitted from the solid light-emitting element,
wherein the wavelength converting unit includes a first member spaced apart from the solid light-emitting element and installed so as to surround the solid light-emitting element, and a second member installed so as to cut off a part of a light path extending from the solid light-emitting element to the first member,
the first member is provided with a first wavelength converting material unevenly coated on an inner surface thereof and is configured such that the relative position of the first member with respect to the second member is changeable, and
the second member is provided with a second wavelength converting material coated on a surface thereof facing the solid light-emitting element.

2. The illumination device of claim 1, wherein the second member is formed into a semi-cylindrical shape or a cylindrical shape having openings in a side surface thereof, and
the first member is formed into a cylindrical shape and is disposed such that a cylinder axis thereof coincides with a cylinder axis of the second member, the first member being rotatable about the cylinder axis of the first member.

3. The illumination device of claim 1, wherein the openings are formed at a specified angular interval with one another along a circumferential direction of the second member, and
the first wavelength converting material is provided at an angular interval equal to the specified angular interval along a circumferential direction of the first member.

4. The illumination device of claim 1, further comprising:
an indicator which indicates the relative position of the first member with respect to the second member and a color rendering property of the light emitted from the illumination device corresponding to the relative position.

5. The illumination device of claim 1, wherein the solid light-emitting element is configured to emit blue light,
the first wavelength converting material includes a red phosphor which is excited by the light emitted from the solid light-emitting element to emit red light, and
the second wavelength converting material includes a yellow phosphor which is excited by the light emitted from the solid light-emitting element to emit yellow light or a green phosphor which is excited by the light emitted from the solid light-emitting element to emit green light.

6. The illumination device of claim 1, wherein the solid light-emitting element is configured to emit light ranging from near-ultraviolet light to violet light,
the first wavelength converting material includes a yellow phosphor which is excited by the light emitted from the solid light-emitting element to emit yellow light, and a phosphor obtained by mixing a red phosphor which is excited by the light emitted from the solid light-emitting element to emit red light and a green phosphor which is excited by the light emitted from the solid light-emitting element to emit green light, and
the second wavelength converting material includes a blue phosphor which is excited by the light emitted from the solid light-emitting element to emit blue light.

7. The illumination device of claim 1, further comprising:
a diffusing unit configured to diffuse and project the light emitted from the solid light-emitting element and the light whose wavelength is converted by the wavelength converting unit to the outside.
